(19) United States
(12) Patent Application Publication
(10) Pub. No.: US 2005/0191174 A1
(43) Pub. Date: Sep. 1, 2005

(54) Centrifugal fan

(76) Inventors: Ling-Zhong Zeng, Lake in the Hills, IL (US); Richard R. Shelby, South Elgin, IL (US); Michael F. Buckley, McHenry, IL (US)

Correspondence Address: MICHAEL BEST & FRIEDRICH, LLP, 100 E WISCONSIN AVENUE, MILWAUKEE, WI, 53202, US

(21) Appl. No.: 10/789,379

(22) Filed: Feb. 27, 2004

(51) Int. Cl. F03B 1/04

(52) U.S. Cl. 415/206

(57) ABSTRACT

The present invention generally relates to a fan and in some aspects to an impeller with increased performance or efficiency. The fan according to some embodiments of the present invention has a housing, an impeller, and a motor driving the impeller. The impeller can be manufactured and/or arranged within the housing to make the fan more efficient under certain operating conditions. In some embodiments, the impeller is equipped with blades having a non-constant radius of curvature. In other embodiments, the impeller is equipped with two sets of blades, which include primary blades and secondary blades. These blades can be offset from each other to increase performance. In yet other embodiments, the space between the secondary blades and the housing can be manipulated to increase performance. Additionally, other embodiments adjust the cross-sectional shape of the flow path through the impeller to increase performance.

### BACKGROUND OF THE INVENTION

As is well-known in the art, many types of fans employ rotatable impellers to move air and other fluids such as fumes, exhaust, or any other type of gas or gasses (for the purposes of this specification, the term air will be used as a non-limiting generic term for all fluids). The impeller moves air through a fan housing, such as a volute or a scroll-type housing and out of an outlet. In many cases, air generally enters the housing axially, travels through the impeller, and leaves the housing generally tangentially.

Air pressure in various locations within a fan housing is typically important to the performance or efficiency of the fan, as is the ability of the fan to produce a pressure differential across the impeller. The pressure producing capacity of a centrifugal fan will vary depending upon certain fan characteristics such as blade depth, tip speed, and blade angle. In turn, the blade angle can be somewhat dependent upon the type of blades carried by the impeller. Blades are said to be forward curved when they are curved so that both the heel and tip of the blade point in the direction of impeller rotation. Blades are said to be radial when they are essentially straight or radial at all points. Another type of blading is referred to as radial tip. As the name suggests, the tip of these blades is radial, but the blade is curved in other spots so that the heel points in the direction of rotation. Still other types of fan blades are backwards-curved and backwards-inclined blades. These types of blades generally point in the direction opposite rotation at the tip and in the direction of rotation at the heel. As previously suggested, the type of blading, due to the blade angle and other factors, can substantially affect the pressure-producing capabilities and the performance of a fan.

A centrifugal fan typically comprises an impeller, an electric motor to drive the impeller, and a scroll-shaped housing forming an air passage through which air moved by the impeller flows. In many cases, the motor is mounted on one side of the housing, while an air suction port is located on the other side of the housing. The impeller of the fan typically has a plurality of blades disposed around the axis of rotation. Each blade has an inner radius or heel end, and an outer radius or tip. These blades are often coupled to or otherwise extend from a back plate or drive plate to form the impeller.

As the impeller rotates, energy is transferred to the air from the rotating blades. These centrifugal forces cause air inside the impeller to move radially through air passages in the impeller, while air from the surrounding environment is sucked into the air intake port. As the impeller continues to rotate, air is continually forced radially out of the impeller and toward the radial periphery of the housing. As the air flows into the housing, the pressure inside the housing begins to increase. Due to the pressure increase, and to the energy transferred to the air due to centrifugal forces, air is blown out of the housing through the air outlet port to downstream locations.

Many centrifugal fans suffer from inefficiency problems stemming from various sources. For example, the shape and configuration of the impeller's blades can substantially reduce the efficiency of the fan assembly. Also, the impeller's position adjacent the housing of a fan can be important to a fan's performance, although such a relationship is often ignored in the design of many conventional fans.

Another challenge in centrifugal fan designs is the balance of fan efficiency versus fan power. In many cases, while fans can be made to operate more efficiently, reduced power consumption can be accompanied by reduced blowing capacity.

Yet another challenge in centrifugal fan designs relates to changing the size of the fan housing and/or impeller to alter efficiency, capacity, or other performance characteristics of fans. For example, centrifugal fans are commonly used to move air in heating, ventilating, and air conditioning (HVAC) units. Most centrifugal fans are mounted to HVAC units using a common fastening arrangement (e.g., a bolt or other fastener pattern shared by different centrifugal fans). Typically, the fastening arrangement at least partially defines the outer periphery of conventional fan housings. Thus, an increase in size or a change in shape of a centrifugal fan housing can often be limited by such a fastening arrangement, or can otherwise require special design changes to the fan housing in order to keep the same fastening locations. Design challenges often arise based upon the shape and size of the fastener heads and their relationship with adjacent walls of the fan housing. For example, walls of an enlarged fan housing can interfere with the ability to position and tighten fan housing fasteners in a desired fastening arrangement.

In light of the problems and limitations of existing centrifugal fans, new centrifugal fan designs and improvements are welcome additions to the art.

### SUMMARY OF THE INVENTION

The fan according to some embodiments of the present invention has a housing, an impeller, and a motor driving the impeller. The impeller can be manufactured and/or arranged within the housing to improve fan performance under certain operating conditions. For example, experiments have indicated that the position and shape of the blades as well as the size and shape of the air passage between the blades of the impeller can have a significant effect on the efficiency of the fan. In some embodiments, the impeller is equipped with blades having a non-constant radius of curvature. In some embodiments, the impeller is equipped with two sets of blades, which include primary blades and secondary blades. These blades can be offset from each other to increase performance. Also, the space between the secondary blades and the housing can be altered to improve performance in some embodiments. Additionally, some embodiments adjust the cross-sectional shape of the flow path through the impeller to improve performance. Finally, some embodiments also adjust the diameter of the housing to improve performance.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which illustrate certain embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numeral indicate like parts:

FIG. 1 is a perspective view of a fan assembly according to an exemplary embodiment of the present invention, shown with a motor and motor mount connected thereto;

FIG. 2 is an exploded perspective view of the fan assembly, motor, and motor mount illustrated in FIG. 1;

FIG. 3 is a plan view of the intake side of the fan assembly shown in FIGS. 1 and 2;

FIG. 4 is a cross-sectional view of the fan assembly shown in FIG. 3, taken along line 4-4 of FIG. 3 and showing the relative position of the impeller with respect to the housing;

FIG. 5 is a plan view of the intake side of the impeller shown in FIGS. 2-4, showing the position and spacing of the primary and secondary blades in phantom;

FIG. 6 is a partial cross-sectional view of the impeller shown in FIG. 5;

FIG. 7 is an exploded perspective view of a fan assembly according to a second exemplary embodiment of the present invention;

FIG. 8 is an intake-side plan view of the fan assembly shown in FIG. 7;

FIG. 9 is a cross-sectional view of the fan assembly shown in FIGS. 7 and 8 taken along line 9-9 of FIG. 8 and showing the relative position of the impeller with respect to the housing;

FIG. 10 is a plan view of the intake side of the impeller shown in FIGS. 7 and 9, showing the position and spacing of the primary and secondary blades in phantom;

FIG. 11 is a cross-sectional view of the impeller shown in FIGS. 7, 9, and 10, taken along line 11-11 of FIG. 10 and showing the shape of the drive plate;

FIG. 12 is a plan view of the drive side of the impeller shown in FIGS. 7 and 9-11;

FIG. 13 is a plan view of a single blade on an impeller according to an exemplary embodiment of the present invention, illustrating various parameters such as blade intake angle, blade exit angle, blade setting angle, and blade chamber-to-chord ratio;

FIG. 14 is a perspective view of an impeller according to a third exemplary embodiment of the present invention;

FIG. 15 is a cross-sectional view of the impeller shown in FIG. 14, taken along line 15-15 of FIG. 14; and

FIG. 16 is a graph illustrating the performance of a fan assembly according to the present invention and a prior art blower according to the present invention.

### DETAILED DESCRIPTION OF THE ILLUSTRATED EMBODIMENTS

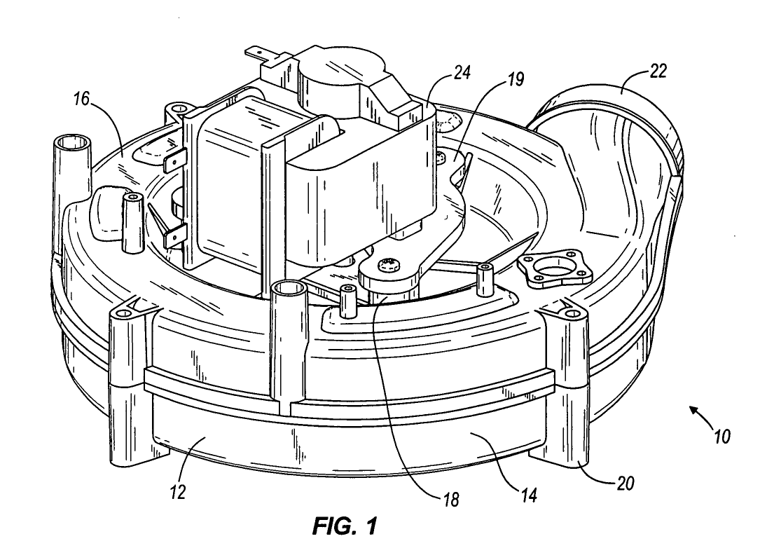

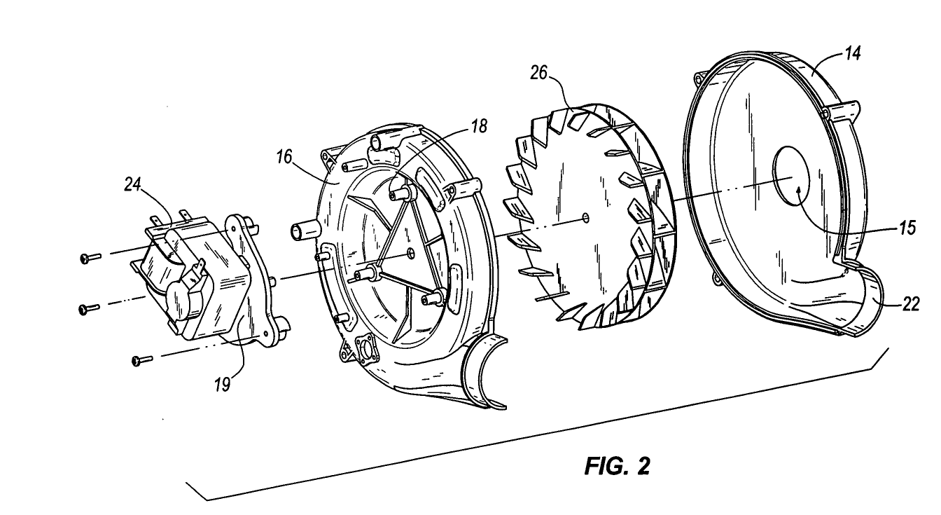

As illustrated in FIGS. 1 and 2, a fan assembly 10 according to an exemplary embodiment of the present invention comprises a housing 12 and an impeller 26 contained at least partially within the housing 12. A motor 24 can be mounted to the housing 12 and can be drivably connected to the impeller 26 in any conventional manner to rotate the impeller 26 in the housing 12. As discussed above, the housing 12 can be a substantially scroll-shaped housing forming an air passage 36 through which air flows. The housing 12 can be constructed in two or more portions 14, 16 to facilitate easy assembly. For example, as shown in FIG. 2, the housing 12 of some embodiments is formed in two portions 14, 16. The first portion 14 can contain an air inlet 15 to allow air to enter the fan 10 axially. The second portion 16 can provide a mounting surface for the motor 24. When the housing 12 is fully assembled, the impeller 26 is at least partially contained within the two portions 14, 16 of the housing 12 as shown in FIG. 2. Furthermore, the housing 12 as assembled forms one or more air passages and flow paths 36 (see FIG. 4) to guide air flow into, through, and out of the impeller 26. Additionally, the housing 12 can also have an air outlet 22 to allow air to exit the fan 10. The two portions 14, 16 of the housing 12 can be coupled in any conventional manner known in the art, including without limitation one or more screws, bolts, rivets, pins, or other conventional fasteners, by crimping, brazing, or welding, by snap fits, interlocking portions, adhesive or cohesive bonding material, and the like.

As previously mentioned, a portion of the housing 12 can have a mounting surface 18 for a motor 24. The motor 24 can be coupled to the surface in any manner known in the art. For example, the motor 24 can be coupled through the use of a motor mount 19 and/or any of the other fastening alternatives described above with reference to the connection between the housing portions 14, 16. As illustrated, the motor mount 19 is coupled to the motor 24 and is used to connect the motor 24 to the housing 12. The illustrated motor mount 19 has three apertures that align with fastening locations on the housing 12. A fastener can extend through the apertures to connect the motor mount 19 (and motor) to the housing 12.

The motor 24 can be any motor suitable to drive the impeller 26, and in the case of the illustrated exemplary embodiment is an electric motor. The motor 24 can be drivably connected to the impeller 26 in any conventional manner, such as via a motor drive shaft 25 rotatably driven by the motor 24 and coupled to the impeller 26.

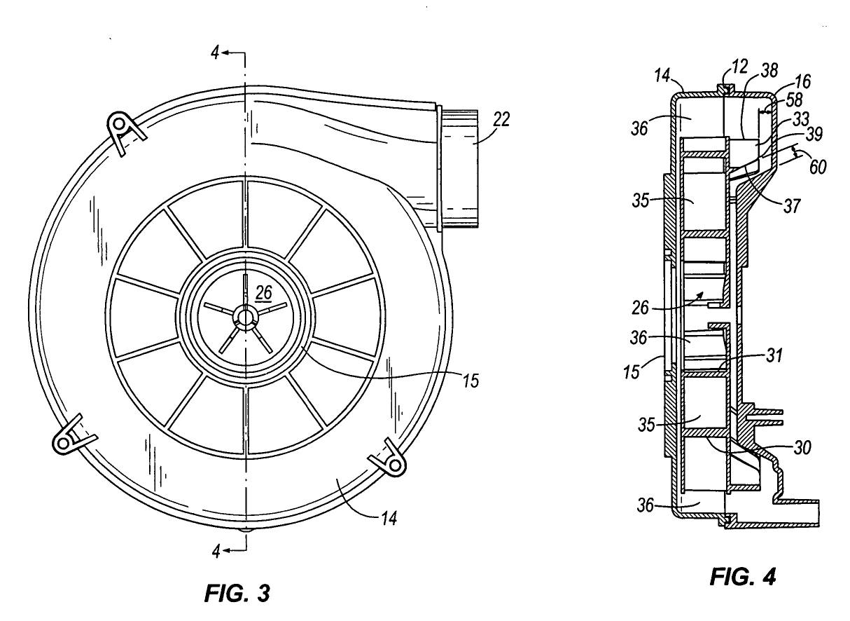

The impeller 26 in the exemplary fan assembly of FIGS. 1-3 is illustrated in greater detail in FIGS. 4-6. The impeller 26 can have any size desired, including without limitation impellers 26 having a diameter of between 4.5 inches and 10.5 inches. However, impellers 26 having a diameter of no less than about 6.5 inches and/or no greater than about 8.5 inches provide good performance results, such as in cases where one or more of the various blade parameters (blade intake angle 40, blade exit angle 44, blade setting angle 48, and blade camber-to-chord ratio, described below) falls within the ranges described below, or in cases where one or more of the impeller parameters (axial and radial gaps between the secondary blades 33 and the housing 12, and the back plate expansion angle 163, also described below) falls within the ranges described below.

The impeller 26 in the illustrated embodiment of FIGS. 1-6 has a central hub 27, a plurality of blades 30, a drive plate or back plate 28, and an intake plate or front plate 29. The central hub 27 is used to couple the impeller 26 to the drive shaft 25 of the motor 24. The hub 27 is coupled to or is integral with the drive plate 28 that extends radially from the drive shaft 25. Although the drive plate 28 is illustrated in several embodiments as being adjacent to the motor side of the housing 12, it can be located anywhere between the motor and intake sides of the housing 12. In other words, the term “drive plate” does not require the plate to be located on the motor side of the internal chamber in the housing. Rather, it indicates that it is coupled to the motor.

In some embodiments, such as the one illustrated in FIG. 4, the drive plate 28 can have a substantially planar shape and run substantially parallel to portions of the motor side of the housing 16 as it extends radially from the hub 27. With such a design, drive plate 28 can also extend substantially parallel to the front plate 29. However, in other embodiments discussed below, the drive plate 28 (or one or more portions of the drive plate) does not need to run substantially parallel to the housing 12 or the front plate 29. Rather, in some embodiments, the drive plate 28 can run at one or more angles with respect to portions of the housing 12 or the intake plate 29. Additionally, in some embodiments, the drive plate 28 can be curved with respect to portions of the housing 12 or the intake plate 29. Furthermore, the drive plate of some embodiments can have any combination of parallel, angled, and curved shapes with respect to portions of the housing and the intake plate 29. Although the arrangement of the drive plate relative to the housing can take many forms, the portions of the housing 12 that extend radially adjacent to the drive plate 28 can run generally parallel to the drive plate regardless of the shape of the plate. In other words, if the plate 28 has angled or curved portions, the housing 12 can also have angled or curved portions to match the shape.

As illustrated in FIG. 4, the intake plate 29 can also have a substantially planar shape and run substantially parallel to portions of the housing 12 as it extends radially away from the hub 27. However, in other embodiments discussed below, the intake plate 29 (or one or more portions of the intake plate) does not run substantially parallel to the housing 12 or the drive plate 28. Rather, in some embodiments, the intake plate 29 can run at one or more angles with respect to portions of the housing 12 or the drive plate 28. Additionally, in some embodiments, the intake plate 29 can be curved with respect to portions of the housing 12 or the drive plate 28. Furthermore, the intake plate 29 of some embodiments can have any combination of parallel, angled, and curved shapes with respect to portions of the housing and the drive plate 28.

As best illustrated in FIG. 4, a plurality of primary blades 30 and secondary blades 33 can be coupled to or integral with the drive plate 28. These blades 30, 33 extend from heel 31, 37 to tip 32, 38 in a radial direction along a portion of the drive plate 28 and also extend axially away from the drive plate 28. In the illustrated embodiment, the primary blades 30 extend axially away from the drive plate 28 in a direction away from the motor 24 and toward the air intake portion of the housing 12. However, in other embodiments, such as those embodiments that use the intake plate 29 as the drive plate, the blades can extend away from intake plate 29 in a direction either toward the motor, away from the motor, or both.

As shown in FIGS. 4 and 6, some embodiments of the impeller can also have an intake plate 29 coupled to or integral with the primary blades 30. The intake plate 29 can have a generally annular shape with an aperture in the middle to allow air to enter the impeller 26. Similar to the drive plate 28, the primary blades 30 can run along the intake plate 29 in a curved, yet generally radial direction. However, they can take several other shapes or combinations of shapes along their length, which are understood by those having ordinary skill in the art. In the illustrated embodiment of FIGS. 1-6, the intake plate 29 is coupled to the primary blades 30 to at least partially define a plurality of air passages 35 through the impeller 26. In those embodiments in which the impeller 26 has intake and drive plates 29, 28, each of the air passages 35 through the impeller 26 can be defined in part by the area contained between two adjacent primary blades 30 and between the intake plate 29 and the drive plate 28.

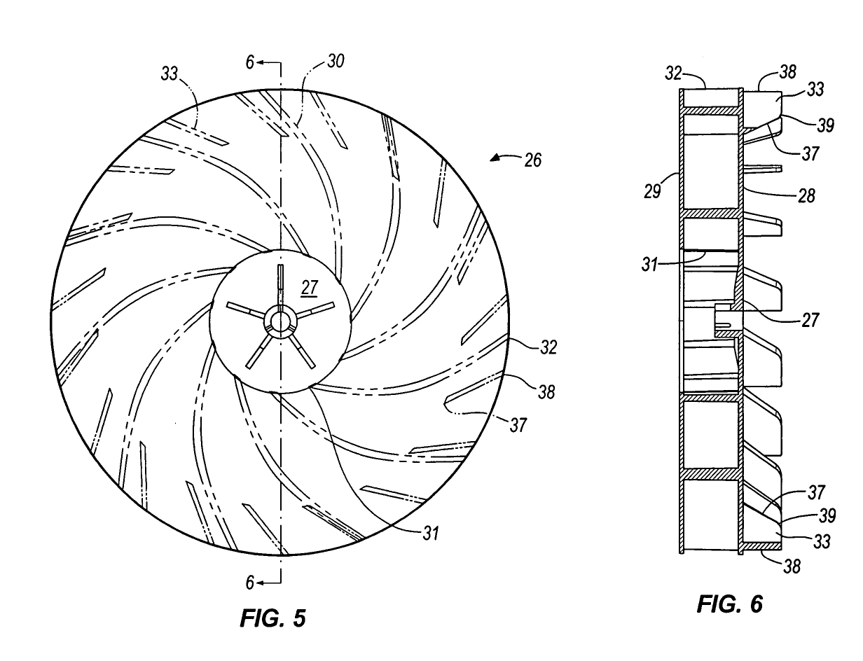

As illustrated in FIG. 5, each primary blade 30 can have a backwards-curved shape, which means that the blades are curved from root to tip and the tip 32 of the blades 30 point in a direction generally opposite the direction of rotation of the impeller 26 and the heel 31 of each blade 30 points generally in the same direction of rotation of the impeller 26. In some embodiments, the root is located circumferentially ahead of the tip in the rotational direction of the impeller. Although any of the other blade shapes discussed in the background above can be used, this general shape can help improve the performance of the fan 10 in certain cases.

In some embodiments of the present invention, the primary blades 30 have a non-constant radius of curvature along the radial length of the blades (from heel 31 to tip 32). For example, as illustrated in FIG. 5, the radius of curvature of each blade is substantially greater at the tip 32 and the heel 31 of the blade 30 when compared to the center of the blade 30. The inventors have discovered that the efficiency of the fan 10 can be increased under certain conditions by using blades with non-constant radii. However, the blades 30 of other embodiments can have a constant radius of curvature or no radius of curvature.

In the following description, certain parameters of the fan blades 30 are referred to in order to help describe the shape and curvature of the blades 30. These parameters include the blade intake angle 40, the blade exit angle 44, the blade setting angle 48, and the blade camber-to-chord ratio. These parameters can be used individually or in combination to at least partially define the curvature and orientation of blades 30 according to the present invention.

In general, the blade intake angle 40 is the angle at which the blade 30 encounters air entering the impeller 26. More particularly, and as shown in FIG. 13, the blade intake angle 40 can be defined by the angle between the chord of the blade 30 (i.e., a line passing through the tip 32 and heel 31 of the blade 30) and a line 42 tangent to the leading surface of the blade 30 at the heel 31 (with reference to the axis of rotation of the impeller 26). In some embodiments, this angle 40 is no less than about 20 degrees and/or is no greater than about 50 degrees. However, the inventors have discovered that a blade intake angle 40 no less than about 27 degrees and/or no greater than about 45 degrees can provide better performance results. The inventors have also discovered that a blade intake angle 40 no less than about 27 degrees and/or no greater than about 40 degrees can provide still better performance results. By way of example only, the blade intake angle 40 in the illustrated embodiment of FIGS. 1-6 is about 31 degrees.

Another parameter that can at least partially define the shape and curvature of the blade 30 is the blade exit angle 44. The blade exit angle 44 can be defined by the angle between a line 45, 145 tangent to a circle defined by the sweep of the blade tip 32 (and tangent to that circle at the blade tip 32) and a line 46 tangent to the trailing surface of the blade 30 at the tip 32 (with reference to the axis of rotation of the impeller 26). In some embodiments, this angle 44 is no less than about 35 degrees and/or is no greater than about 60 degrees. However, the inventors have discovered that a blade exit angle 44 no less than about 40 degrees and/or no greater than about 55 degrees can provide better performance results. The inventors have also discovered that a blade exit angle 44 no less than about 45 degrees and/or no greater than about 55 degrees can provide still better performance results. By way of example only, the blade exit angle 44 in the illustrated embodiment of FIGS. 1-6 is about 51 degrees.

Yet another parameter that can at least partially define the shape and curvature of the blade 30 is the blade setting angle 48. The blade setting angle 48 can be defined by the angle between a line 49 extending from the tip 32 to the heel 31 of the blade 30 (e.g., a chord line of the blade 30 in some embodiments) and a line 50 extending from the tip 32 of the blade 30 to the axis of rotation of the impeller 26. In some embodiments, this angle 48 is no less than about 5 degrees and/or is no greater than about 30 degrees. However, the inventors have discovered that a blade setting angle 48 no less than about 10 degrees and/or no greater than about 25 degrees can provide better performance results. The inventors have also discovered that a blade setting angle 48 of no less than about 10 degrees and/or no greater than about 20 degrees can provide still better performance results. By way of example only, the blade setting angle 48 in the illustrated embodiment of FIGS. 1-6 is about 15 degrees.

The blade camber-to-chord ratio is yet another parameter that can be used to at least partially define the shape and curvature of the blade 30. As the name indicates, this parameter is the ratio of the blade camber to the length of the blade chord 53. As shown in FIG. 13, the blade camber can be measured in terms of the shortest distance between a line 49 drawn from the tip 32 to the heel 31 of the blade 30 and the point of deepest camber 51 from that line 49 (measured perpendicularly from the line 49). The blade chord length, on the other hand, is a measurement along a straight line 49 from the tip 32 to the heel 31 of the blade 30. In some embodiments, the blade camber-to-chord ratio (expressed as a percentage) is no less than about 5% and/or is no greater than about 20%. However, the inventors have discovered that a blade camber-to-chord ratio no less than about 10% and/or no greater than about 20% can provide better performance results. The inventors have also discovered that a blade camber-to-chord ratio no less than about 10% and/or no greater than about 15% can provide still better performance results. By way of example only, the blade camber-to-chord ratio in the illustrated embodiment of FIGS. 1-6 is about 13%.

As illustrated in FIG. 4-6 and as mentioned above, some embodiments of the impeller 26 also utilize secondary blades 33. Although secondary blades 33 are illustrated in several embodiments, they are not essential to the operation of the fan 10. Therefore, some embodiments of the present invention only utilize primary blades 30. However, in those embodiments that do utilize secondary blades 33, the secondary blades 33 can extend from a heel portion 37 to a tip portion 38 in a generally radial direction along a portion of the drive plate 28 and also extend axially away from the drive plate 28. The secondary blades 33 can extend toward the motor side housing portion 16, and can also extend a relatively short distance in a generally radial direction. Each secondary blade 33 can also have a point defining the maximum axial distance of the secondary blade 33 from the drive plate 28, or can define a line 39 (see FIG. 6) at this distance. This point or line 39 is located and/or extends between the heel portion 37 and the tip portion 38 of the secondary blade 33. As best illustrated in FIG. 5, the secondary blades 33 can be angled with respect to the radial direction of the drive plate 28 to form intake and exit angles. Furthermore, although it is not illustrated, the secondary blades 33 can be oriented at any angle with respect to the axis of rotation and can be coupled to the intake plate 29 instead of or in addition to the being coupled to drive plate 28. In such embodiments, the secondary blades 33 can extend toward the intake side of the housing 12.

In those embodiments utilizing secondary blades 33, certain parameters can be adjusted to improve the performance of the fan 10. For example, regardless of the shape of the secondary blades 33, the secondary blades 33 according to some embodiments are immediately adjacent an inside surface of the housing 12. Positioning the impeller 26 with respect to the housing 12 so that the axial spacing between the secondary blades 33 and the housing 12 is of a particular size or sizes and/or is within a size range (as described below) can generate good performance results of the fan 10. Thus, as shown in FIG. 4 for example, portions of the housing 12 adjacent the drive plate 28 can have a profile generally matching that portion of the impeller 26 from which the secondary blades 33 extend. In some embodiments, this matching profile has been found to increase performance of the fan assembly 10.

For example, as shown in FIG. 4, the spacing between the housing 12 and the secondary blades 33 can be at least partially defined by an axial gap 58 and a radial gap 60 between each secondary blade 33 and the housing 12. As illustrated, the axial gap 58 is the distance between the secondary blades 33 and the housing 12 in the axial direction. More particularly, in some embodiments, this gap can be defined by the axial distance between the motor side portion 16 of the housing 12 and the point or line 39 defining the maximum axial distance of the secondary blades 33 from the drive plate 28. In some embodiments, the axial gap 58 is no less than about 0.075 inches and/or is no greater than about 0.50 inches. However, the inventors have discovered that an axial gap 58 no less than about 0.125 inches and/or no greater than about 0.45 inches can provide better performance results. The inventors have also discovered that an axial gap 58 of between about 0.15 inches and about 0.40 inches can provide still better performance results. By way of example only, the axial gap 58 in the illustrated exemplary embodiment of FIGS. 1-6 is about 0.27 inches.

The radial gap 60 can be defined as the distance between the secondary blades 33 and the housing 12 in a generally inward radial direction (i.e., toward the axis of rotation). More particularly, this gap 60 can be defined by the distance between the medial or heel portion 37 of the blade 33 and the housing 12. Since the heel portion 37 of the blade 33 can have a variety of angular positions with respect to the drive plate 28, this gap 60 can have both a radial component and an axial component. For example, the gap 60 between the housing 12 and the heel portion 37 of the secondary blades 33 illustrated in FIG. 4 has both a radial component and an axial component. However, it will be appreciated that in other embodiments, this gap 60 can be defined entirely or substantially entirely by a radial distance (in secondary blades 33 having other shapes). As used herein and in the appended claims, this gap 60 will be referred to herein only as a “radial gap” for ease of identification only. In some embodiments, the radial gap 58 is no less than about 0.075 inches and/or is no greater than about 0.50 inches. However, the inventors have discovered that a radial gap 58 no less than about 0.125 inches and/or no greater than about 0.45 inches can provide better performance results. The inventors have also discovered that a radial gap 58 of between about 0.15 inches and about 0.40 inches can provide still better performance results. By way of example only, the radial gap 58 in the illustrated exemplary embodiment of FIGS. 1-6 is about 0.23 inches.

The spacing of blades 30, 33 on the impeller 26 can affect the performance of the fan 10. In some embodiments, either or both sets of blades 30, 33 can be uniformly spaced to provide desired performance results. For example, the impeller 26 illustrated in FIG. 5 has uniformly spaced blades 30 and uniformly spaced secondary blades 33. However, either or both sets of blades 30, 33 can be arranged in other manners (e.g., non-uniform spacing between the blades 30, 33 in either or both sets) in other embodiments.

Although the use of primary blades 30 and secondary blades 33 can increase the performance of the fan assembly 10, experiments have indicated that in certain instances the use of both type of blades 30, 33 can increase the amount of noise emanating from the assembly. One such instance is when the blade count of the primary blades 30 is a multiple of the blade count of the secondary blades 33 (or vice versa). Accordingly, in some embodiments of the present invention, the ratio of blades 30 to secondary blades 33 is selected so that neither is a multiple of the other. This feature can reduce noise and improve pressure characteristics within the fan assembly 10. By way of example, only, the impeller 26 in the illustrated embodiment of FIGS. 1-6 has eleven equally spaced blades and nineteen equally spaced secondary blades 33.

As illustrated in FIG. 5, when the blade count of the secondary blades 33 do not equal the blade count of the primary blades 30 (or one is a not multiple of the other), and both sets of blades are uniformly spaced among themselves, the secondary blades 33 and the primary blades 30 do not appear to have a repeating sequence. In other words, the two types of blades 30, 33 appear to be randomly spaced with respect to one another. This is understood to help reduce sound harmonics. However, in other embodiments, any ratio of primary blades 30 to secondary blades 33 can be employed as desired (including ratios in which either set of blades 30, 33 is a multiple of the other), regardless of whether the blades 30, 33 in each set of blades is uniformly or non-uniformly spaced.

Although some blade spacings and ratios are described above, it should be noted that still other arrangements, numbers, spacings, and positions of the primary blades 30 and secondary blades 33 can be employed depending at least partially upon the performance characteristics desired and the operating conditions of the fan 10.

The operation of the fan assembly 10 illustrated in FIGS. 1-6 and 13 will now be briefly described. As best illustrated in FIGS. 2 and 4, the fan assembly 10 is powered by the motor 24. As the motor 24 rotates, the drive shaft 25 causes the impeller 26 to rotate. As the impeller 26 rotates, energy is transferred to air, causing air inside the impeller 26 to move radially through air passages 35 of the impeller 26 while air from the surrounding environment is sucked into the air intake port 15. As the air is sucked into the air intake port 15, the air encounters the primary blades 30 having an intake angle 40 as described above. The air then passes through the air passage 35 and along the surfaces of the blades 30. As the impeller 26 continues to rotate, air is continually forced radially out of the impeller 26 and into the air passages 36 of the housing 12. As the air flows into the housing 12, a heightened pressure within the housing 12 causes air to be forced out of the housing 12 through the air outlet port 22.

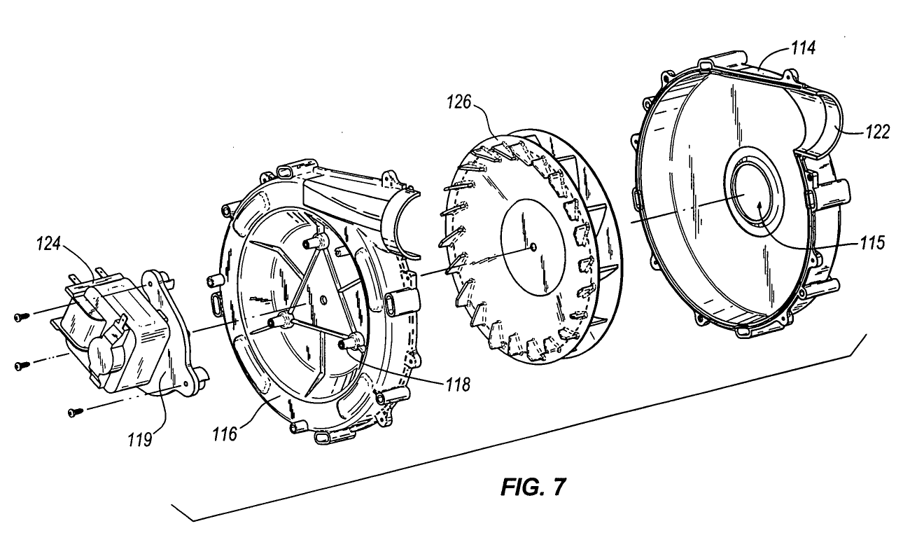

FIGS. 7-13 illustrate yet another embodiment of the present invention. Much of the structure of the fan assembly 110 illustrated in FIGS. 7-13 is similar to the fan assembly 10 described above with reference to FIGS. 1-6, and therefore shares the same reference numerals in the 100 series for those elements and features that correspond to elements and features in the embodiment of FIGS. 1-6. Only those elements and features that are different from the previous embodiments will be described in detail below. For a more complete understanding of the elements and features (and alternatives thereto) of the embodiment illustrated in FIGS. 7-13, reference is hereby made to the discussion of the embodiments above.

As illustrated in FIGS. 7-9, the fan assembly 110 of this embodiment generally comprises a housing 112, a motor 124 coupled to the housing 112, and an impeller 126 contained at least partially within the housing 112.

As shown in FIGS. 7 and 9-12, the impeller 126 of this embodiment has a central hub 127, a plurality of blades 130, 133, a drive plate 128, and an intake plate 129. The central hub 127 is used to couple the impeller 126 to the drive shaft 125 of the motor 124. The hub 127 is connected to or is integral with part of the drive plate 128 that extends radially from the drive shaft 125. In this embodiment, at least a portion of the drive plate 128 is angled with respect to the intake plate 129 or vice versa. More specifically, the drive plate 128 has an annular portion that is disposed at an angle of expansion away from the intake plate 129. Therefore, the space between the plates 128, 129 in this annular portion of the drive plate 128 increases with increasing radial distance from the drive shaft 25. In other words, the axial distance between the two plates increases as the radial distance of the angled section increases from the axis of the plate. In some embodiments, the cross-section of the wall of the drive plate 128 in this annular portion is substantially flat, yet angled as shown in FIG. 9. Although the drive plate 128 illustrated in FIGS. 9-12 has an annular portion defined at an angle as described above, it should be noted that any amount of the drive plate 128 can be angled as just described (e.g., along substantially the entire radius of the drive plate 128 extending from the drive shaft 25, along only a radially inner, middle, or outer portion of the drive plate 128, along any combination of portions of the drive plate 128, and the like).

As indicated above, the drive plate 128 does not necessarily need to be the plate that is non-planar. Rather, the intake plate 129 can have a non-planar profile. Additionally, both plates can have a non-planar profile. In such embodiments, the relationship between the intake and drive plates (regardless of which one is angled) can be selected to provide an increasing axial distance between the plates with increasing radial distance from the axis of rotation of the impeller.

By employing the shape of the impeller 126 described above and illustrated in FIGS. 9-12, a cross-sectional shape is defined between adjacent blades 130 and between the drive and intake plates 128, 129. This cross-sectional shape increases with increasing radial distance from the drive shaft 125, due at least in part by the shape of the blades 130 and by the fact that at least a portion of the drive plate 128 is angled away from the at least a portion of the intake plate 126. Accordingly, air moving between the blades 130 in a radially outward direction as described above passes through an expanding area.

In the illustrated exemplary embodiment of FIGS. 9-13, the increasing space between adjacent blades 130 of the impeller 126 is due in part by a portion of the drive plate 128 being angled away from the intake plate 129 as described above. The degree of increase of this space can be defined in part by an expansion angle 163 as shown in FIG. 9.

In other embodiments, the space between the drive and intake plates 128, 129 increases along a curved or stepped portion of the drive plate 128 rather than by a substantially flat annular portion of the drive plate 128 oriented at an angle with respect to the intake plate 129 as described above. In other words, at least a portion of the drive plate 128 (or intake plate 129) can be curved, stepped, or have any other shape defining an increasing distance from the intake plate 129 with increasing radial distance from the drive shaft 125. In this manner, the cross-sectional shape between adjacent blades 130 and between the drive and intake plates 128, 129 of the impeller 126 increases in size with increasing radial distance from the drive shaft 125.

Regardless of the shape of the drive plate 128 that helps to define an increasing cross-sectional shape between adjacent blades 130 and between the plates 128, 129, it should be noted that such an increase can be constant or non-constant along the radius of the impeller 126.

With reference again to the illustrated exemplary embodiment of FIGS. 7-13, in some embodiments at least a portion of the drive plate 128 is oriented at an expansion angle with respect to the intake plate 129 as described above. In some embodiments, this expansion angle 163 is at least about 0 degrees and/or is no greater than about 25 degrees. However, the inventors have discovered that an expansion angle 163 that is at least about 0 degrees and/or is no greater than about 20 degrees can provide better performance results. The inventors have also discovered that an expansion angle 163 of at least about 0 degrees and/or no greater than about 15 degrees can provide still better performance results. By way of example only, the expansion angle 163 of the impeller 126 in the illustrated embodiment of FIGS. 7-13 is about 15 degrees. In those embodiments in which the drive plate 128 (or a portion thereof) is curved or is otherwise shaped in another manner to define an increasing distance from the intake plate 129 as described above, the expansion angle 163 can be measured by the angle between the intake plate 129 and a radial line extending from the beginning to the end of that portion of the drive plate 128 expanding away from the intake plate 129.

As best illustrated in FIGS. 9-13, a plurality of primary blades 130 and secondary blades 133 can be coupled to the drive plate 128. These blades extend from the heel 131, 137 to the tip 132, 138 of each blade 130, 133 in a generally radial direction along at least a portion of the drive plate 128, and also extend axially away from the drive plate 128. As illustrated, the primary blades 130 extend axially away from the drive plate 128 in a direction away from the motor 124 and toward the air intake portion of the housing 112. The secondary blades 133, however, extend axially away from the drive plate 128 in a direction toward the motor 124.

As best shown in FIGS. 9 and 11, the primary blades 130 can also be connected to or integral with an intake plate 129. Similar to the drive plate 128, the primary blades 130 can run along the intake plate 129 in a curved, yet generally radial direction. As illustrated, the intake plate 129 can have a generally annular shape with an aperture in the middle to allow air to enter the impeller 126. In the illustrated exemplary embodiment of FIGS. 7-13, the intake plate 129, drive plate 128, and primary blades 130 define a plurality of air passages 135 through the impeller 126.

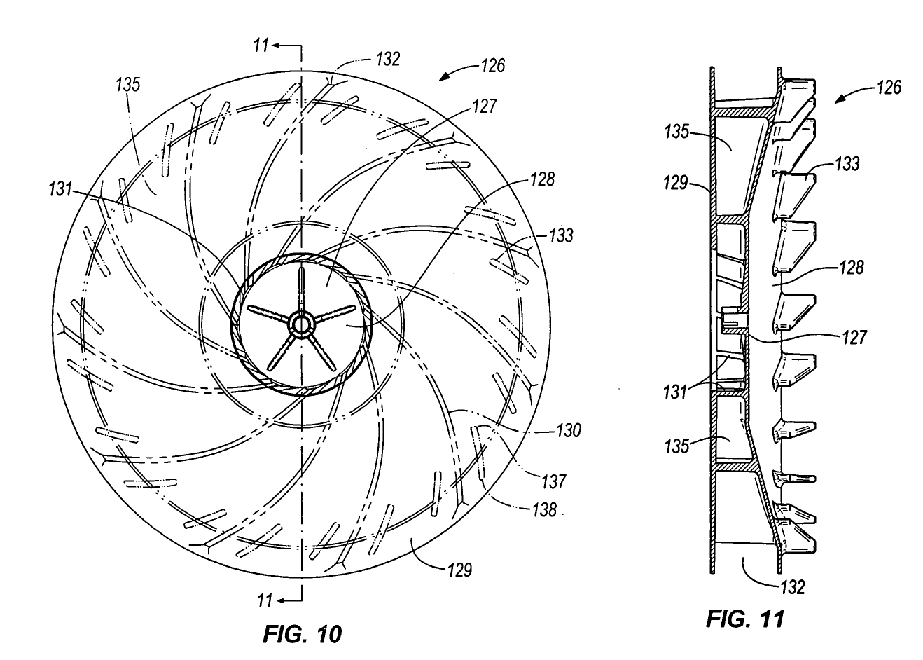

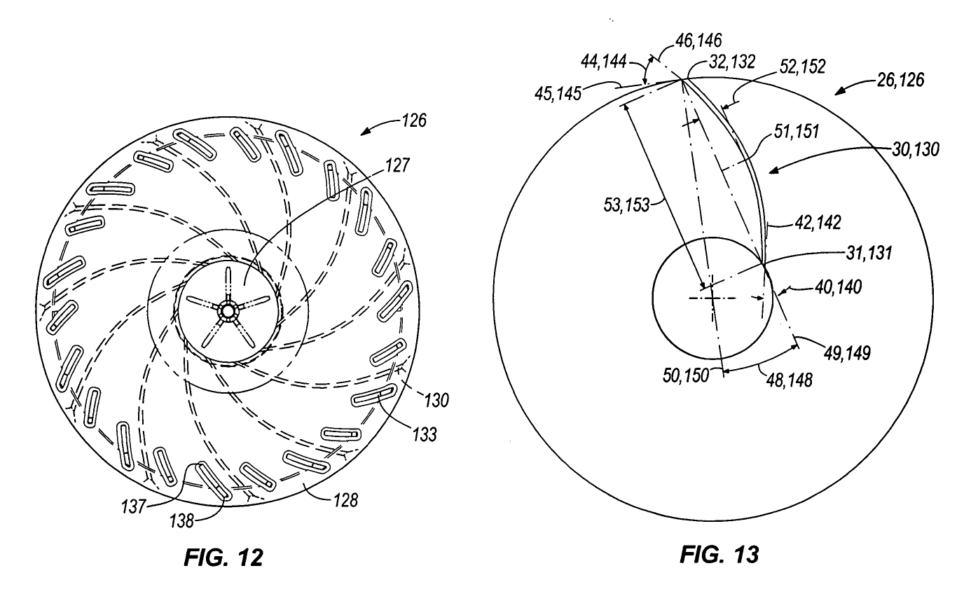

As illustrated in FIGS. 10 and 12, each primary blade 130 can have a backwards-curved shape. With a backwards-curved shape, the tip 132 of the blades 130 point in a direction opposite the direction of rotation of the impeller 126, and the heel 131 of each blade 130 points in the direction of rotation of the impeller 126. Although any of the other blade shapes discussed herein can be employed, this general blade shape can help improve the performance of the fan 110 in certain embodiments.

In some embodiments, the curvature of the primary blades 130 in the embodiment of FIGS. 7-13 has a non-constant radius along the radial length of the blades 130. For example, as illustrated in FIGS. 10 and 12, the radius of curvature of each blade 130 is greater at the tip 132 and the heel 131 of the blade 130 compared to the center of the blade 130. However, the blades 130 in other embodiments have a constant radius or have substantially no radius.

As with the embodiments of the present invention described above with reference to FIGS. 1-6 and 13, the blade intake angle 140, blade exit angle 144, blade setting angle 148, and blade camber-to-chord ratio can be employed to help define the shape of the blades 130. These parameters can be used individually or in combination to at least partially define the curvature and orientation of the blades 130. Reference is hereby made to the description above (in connection with the embodiment of FIGS. 1-6 and 13) regarding the values of these angles, ranges of angles, ratios, and ranges of ratios in the embodiment of FIGS. 7-13. In this regard, various features described above in connection with the embodiment of FIGS. 1-6 and 13 are provided with corresponding reference numerals in FIG. 13 in the 100 series.

As discussed above with reference to the earlier embodiments, the spacing of blades 130 (and secondary blades 133, if employed) on the impeller 126 can affect performance of the fan 110. Returning to FIGS. 10 and 12, this illustrated embodiment has a number of primary blades 130 uniformly spaced about the impeller 126 and a number of secondary blade 133 uniformly spaced about the impeller 126, although either or both sets of blades 130, 133 can be non-uniformly spaced about the impeller 126 in other embodiments.

As also discussed above with reference to the earlier embodiments, the number of blades 130, 133 in each set of blades 130, 133 can also affect performance of the fan 110. With continued reference to FIGS. 10 and 12, this illustrated embodiment has eleven primary blades 130 and twenty-two secondary blades 133. If desired, impeller noise can be reduced and impeller efficiency can be increased in some cases by varying the spacing of the primary blades 130 and/or secondary blades 133. Thus, the primary blades 130 can be circumferentially positioned non-uniformly on the impeller 126 and/or can be circumferentially positioned non-uniformly with respect to the secondary blades 133 of the impeller 126. Similarly, the secondary blades 133 can be circumferentially non-uniformly spaced on the impeller 126.

Another feature that can improve fan performance is the use of two or more types of secondary blades 133 on the same impeller 126, such as secondary blades 133 having different sizes and/or shapes at different circumferential positions about the impeller 126. By way of example only, two sizes of secondary blades 133 are employed in the illustrated embodiment of FIGS. 7-13, and are arranged in alternating format about the circumference of the impeller 126 (i.e., secondary blades 133 each having a length and alternating with secondary blades 133 having a slightly longer length). In other embodiments, secondary blades 133 having different camber-to-chord ratios, setting angles, intake angles, exit angles, heights, and/or other characteristics can be arranged in alternating format about the circumference of the impeller 126. Also, it should be noted alternating secondary blade types (if employed) can be equally or unequally spaced about the impeller 126 as desired.

Although some blade spacings and ratios are described above, it should be noted that still other arrangements, numbers, spacings, and positions of the primary blades 130 and secondary blades 133 can be employed depending at least partially upon the performance characteristics desired and the operating conditions of the fan 110.

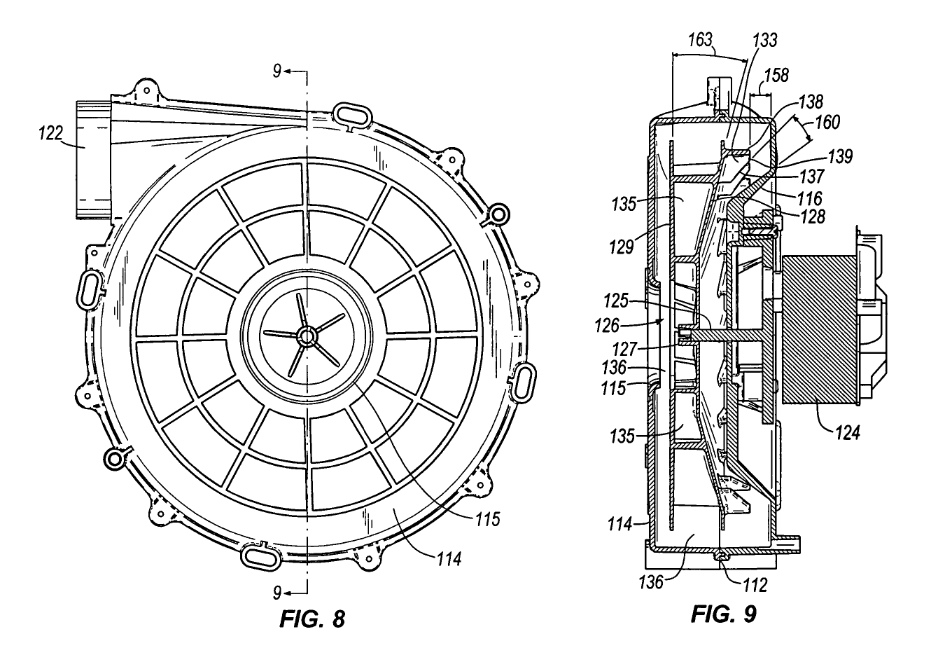

The operation of the second embodiment will now be briefly described. As best illustrated in FIGS. 8 and 9, operation of this embodiment can begin by powering the motor 124. As the motor 124 rotates, the drive shaft 125 causes the impeller 126 to rotate. As the impeller 126 rotates, energy is transferred to air due to centrifugal action. This centrifugal action causes air inside the impeller 126 to move radially through air passages 135 of the impeller 126, while air from the surrounding environment is sucked into the air intake port 115. As the impeller 126 continues to rotate, air is continually forced radially out of the impeller 126 and into the housing 112. As the air flows into the housing 112, the pressure inside the housing 112 begins to increase. Due to the pressure increase, and to the energy transferred to the air due to centrifugal action, air is blown out of the housing 112 through the air outlet port 122 and back into the environment.

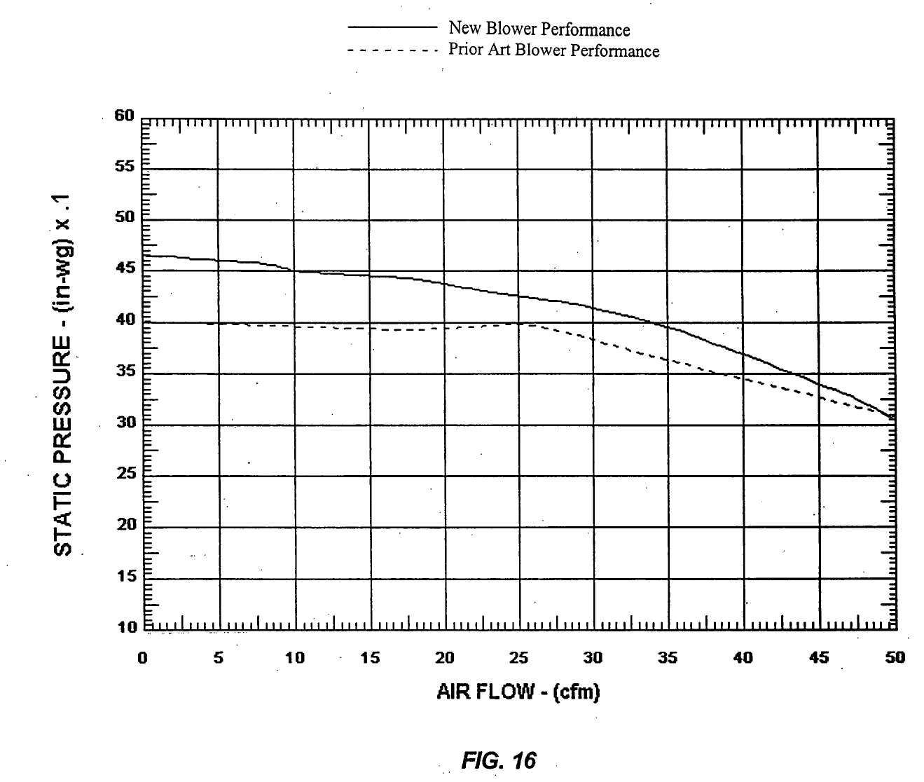

The fan assemblies 10, 110 of the present invention illustrated in FIGS. 1-13 can provide improved performance results compared to conventional fans. For example, for a given airflow of a fan assembly 10, 110 according to the present invention, the static pressure of the fan assembly 10, 110 is significantly greater than conventional fans. This difference is illustrated in FIG. 16, in which increased static pressures of a fan assembly according to the present invention are compared to static pressures of a conventional fan assembly across a range of fan assembly airflows. The test data illustrated in FIG. 16 was measured at an air density of 0.075 lb./cu.ft and at a fan speed of 3450 RPM, and clearly illustrates improved static pressures of the fan assembly according to the present invention.

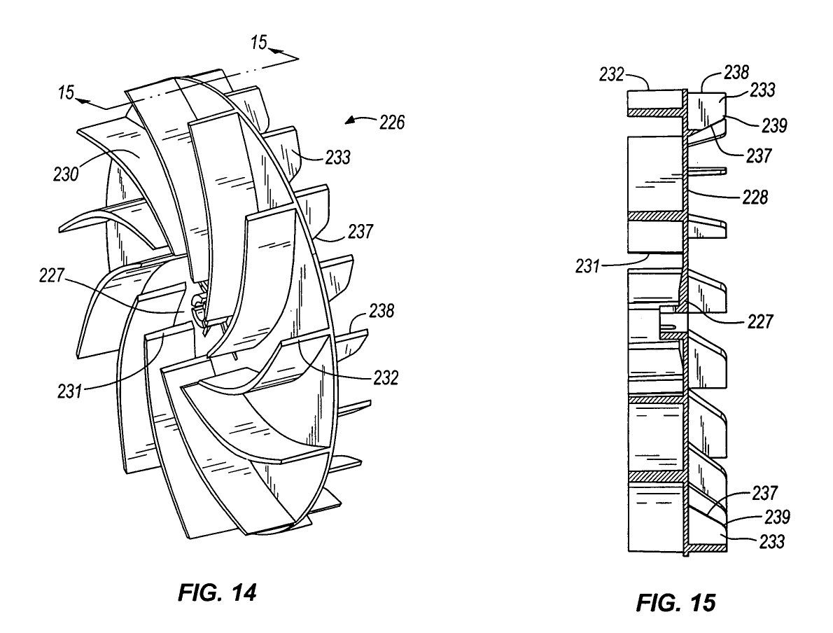

Yet another embodiment of an impeller 226 according to the present invention is illustrated by way of example in FIGS. 14 and 15. Much of the structure of the impeller 226 illustrated in FIGS. 14 and 15 is similar to the impeller 26 described above with reference to FIGS. 1-6, and therefore shares the same reference numerals in the 200 series for those elements and features that correspond to elements and features in the embodiment of FIGS. 1-6. Only those elements and features that are different from the impeller 26 described above with reference to FIGS. 1-6 will be described in detail below. For a more complete understanding of the elements and features (and alternatives thereto) of the impeller illustrated in FIGS. 14 and 15, reference is hereby made to the discussion above in connection with the embodiment of FIGS. 1-6.

In some embodiments, it is desirable to employ an impeller 226 having only a single plate 228 to which the primary blades 230 and/or the secondary blades 233 are attached or are integral. In such embodiments, the impeller 226 is similar to those described above, but has no intake plate. This type of impeller 226 can have any number of primary and secondary blades 230, 233 having any shape and arranged in any manner as described above, and in some embodiments has primary and secondary blades 230, 233 shaped and arranged as described above with reference to the first illustrated embodiment of FIGS. 1-6.

An impeller 226 having only a single plate 228 as just described can be significantly easier and less costly to manufacture and/or assemble. Also, such an impeller 226 can be significantly lighter than others having intake and drive plates. As necessary to control performance of the impeller 226, the impeller 226 can be positioned within a fan housing immediately beside a wall in which the fan inlet is defined (thereby limiting “leakage” of air around the impeller 226 between the impeller 226 and the housing).

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, various alternatives to the features and elements of the fan assemblies are described with reference to each fan assembly. With the exception of features, elements, and manners of operation that are mutually exclusive of or are inconsistent each illustrated embodiment described above, it should be noted that the alternative features, elements, and manners of operation described with reference to each of the fan assemblies are applicable to the other embodiments.

Additionally, as indicated above, some embodiments can omit certain elements or portions of elements and yet fall within the spirit and scope of the present invention. For example, the impeller of some embodiments can operate without a hub as illustrated. The motor in these embodiments can be drivably connected to the impeller in many ways that do not employ a hub as illustrated. Also, as described above, the impeller of some embodiments do not need to have either or both of the drive and intake plates illustrated. These features may not be necessary in some embodiments that focus on aspects of the invention that increase performance, but do not rely on the shape, design, or existence of these plates.

1. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades coupled to the plate and extending toward the back wall, each blade having a peripheral edge at least partially defining a heel portion located a radial distance from the axis, a tip portion located a greater radial distance from the axis, and a point positioned a maximum axial distance from the plate, the point axially separated from the back wall of the housing by a first distance no greater than about 0.5 inches.

2. The fan as claimed in claim 1, wherein a portion of the back wall adjacent the fan blades has a cross-sectional shape substantially similar to a peripheral shape of each fan blade.

3. The fan as claimed in claim 1, wherein the first distance is no greater than about 0.45 inches.

4. The fan as claimed in claim 1, wherein the plurality of fan blades is a first plurality of fan blades, the fan further comprising a second plurality of fan blades coupled to the plate and extending toward the inlet wall.

5. The fan as claimed in claim 4, wherein each of the second plurality of fan blades is curved and has a non-constant radius of curvature.

6. The fan as claimed in claim 3, wherein:
at least a portion of the back wall and at least a portion of the fan blades are located at a common axial position; and
the at least a portion of the back wall is radially spaced from the at least a portion of the fan blades by a second distance no greater than about 0.5 inches.

7. The fan as claimed in claim 6, wherein the second distance is no greater than about 0.45 inches.

8. The fan as claimed in claim 1, wherein:
at least a portion of the back wall and at least a portion of the fan blades are located at a common axial position; and
the at least a portion of the back wall is radially spaced from the at least a portion of the fan blades by a second distance no greater than about 0.5 inches.

9. The fan as claimed in claim 8, wherein the second distance is no greater than about 0.45 inches.

10. The fan as claimed in claim 1, wherein:
the plate is non-planar, and has a varying axial position with increasing radial distance from the axis;
at least a portion of the plate defines an angle of expansion with respect to a plane orthogonal to the axis; and
the angle of expansion is greater than about 0 degrees and is less than about 25 degrees.

11. The fan as claimed in claim 10, wherein the angle of expansion is greater than about 0 degrees and is less than about 20 degrees.

12. The fan as claimed in claim 3, wherein:
the plate is non-planar, and has a varying axial position with increasing radial distance from the axis;
at least a portion of the plate defines an angle of expansion with respect to a plane orthogonal to the axis; and
the angle of expansion is greater than about 0 degrees and is less than about 25 degrees.

13. The fan as claimed in claim 12, wherein the angle of expansion is greater than about 0 degrees and is less than about 20 degrees.

14. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades coupled to the plate and extending toward the back wall, each blade having a peripheral edge at least partially defining a heel portion located a radial distance from the axis and a tip portion located a greater radial distance from the axis,
wherein at least a portion of the back wall and at least a portion of the fan blades are located at a common axial position and are radially spaced from each other by a distance no greater than about 0.5 inches.

15. The fan as claimed in claim 14, wherein a portion of the back wall adjacent the fan blades has a cross-sectional shape substantially similar to a peripheral shape of each fan blade.

16. The fan as claimed in claim 14, wherein the plurality of fan blades is a first plurality of fan blades, the fan further comprising a second plurality of fan blades coupled to the plate and extending toward the inlet wall.

17. The fan as claimed in claim 16, wherein each of the second plurality of fan blades is curved and has a non-constant radius of curvature.

18. The fan as claimed in claim 14, wherein the distance is no greater than about 0.45 inches.

19. The fan as claimed in claim 14, wherein:
the plate is non-planar, and has a varying axial position with increasing radial distance from the axis;
at least a portion of the plate defines an angle of expansion with respect to a plane orthogonal to the axis; and
the angle of expansion is greater than about 0 degrees and is less than about 25 degrees.

20. The fan as claimed in claim 19, wherein the angle of expansion is greater than about 0 degrees and is less than about 20 degrees.

21. The fan as claimed in claim 18, wherein:
the plate is non-planar, and has a varying axial position with increasing radial distance from the axis;
at least a portion of the plate defines an angle of expansion with respect to a plane orthogonal to the axis; and
the angle of expansion is greater than about 0 degrees and is less than about 25 degrees.

22. The fan as claimed in claim 21, wherein the angle of expansion is greater than about 0 degrees and is less than about 20 degrees.

23. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising a chord;
a heel end;
a tip end opposite the heel end and located a greater radial distance from the axis than the heel end; and
an intake angle defined between the chord of the fan blade and a straight line extending tangentially from the heel end of the fan blade, the intake angle being no less than about 20 degrees and no greater than about 50 degrees,
wherein the plate is non-planar, and has a varying axial position with increasing radial distance from the axis, at least a portion of the plate defining an angle of expansion with respect to a plane orthogonal to the axis, the the angle of expansion being greater than about 0 degrees and less than about 25 degrees.

24. The fan as claimed in claim 23, wherein the plurality of fan blades is a first plurality of fan blades, the fan further comprising a second plurality of fan blades coupled to the plate and extending toward the back wall.

25. The fan as claimed in claim 23, wherein each of the plurality of fan blades is curved and has a non-constant radius of curvature.

26. The fan as claimed in claim 23, wherein the intake angle is no less than about 27 degrees and is no greater than about 45 degrees.

27. The fan as claimed in claim 23, wherein:
the tip ends of the fan blades trace an imaginary circle about the axis upon rotation of the impeller; and
each fan blade further comprises an exit angle defined between a line tangent to the imaginary circle at the tip end of the fan blade and a straight line extending tangentially from the tip end of the fan blade, the exit angle being no less than about 35 degrees and no greater than about 60 degrees.

28. The fan as claimed in claim 27, wherein the exit angle is no less than about 40 degrees and is no greater than about 55 degrees.

29. The fan as claimed in claim 23, wherein an angle between the chord of each blade and a straight line extending from the axis to the tip end of the fan blade is no less than about 5 degrees and is no greater than about 30 degrees.

30. The fan as claimed in claim 23, wherein an angle between the chord of each blade and a straight line extending from the axis to the tip end of the fan blade is no less than about 10 degrees and is no greater than about 25 degrees.

31. The fan as claimed in claim 23, wherein each fan blade has a camber to chord ratio of no less than about 5% and no greater than about 20%.

32. The fan as claimed in claim 23, wherein each fan blade has a camber to chord ratio of no less than about 10% and no greater than about 20%.

33. The fan as claimed in claim 23, wherein the angle of expansion is less than about 20 degrees.

34. The fan as claimed in claim 33, wherein the intake angle is no less than about 27 degrees and is no greater than about 45 degrees.

35. The fan as claimed in claim 33, wherein:
the tip ends of the fan blades trace an imaginary circle about the axis upon rotation of the impeller; and
each fan blade further comprises an exit angle defined between a line tangent to the imaginary circle at the tip end of the fan blade and a straight line extending tangentially from the tip end of the fan blade, the exit angle being no less than about 35 degrees and no greater than about 60 degrees.

36. The fan as claimed in claim 35, wherein the exit angle is no less than about 40 degrees and is no greater than about 55 degrees.

37. The fan as claimed in claim 33, wherein an angle between the chord of each blade and a straight line extending from the axis to the tip end of the fan blade is no less than about 5 degrees and is no greater than about 30 degrees.

38. The fan as claimed in claim 33, wherein an angle between the chord of each blade and a straight line extending from the axis to the tip end of the fan blade is no less than about 10 degrees and is no greater than about 25 degrees.

39. The fan as claimed in claim 33, wherein each fan blade has a camber to chord ratio of no less than about 5% and no greater than about 20%.

40. The fan as claimed in claim 33, wherein each fan blade has a camber to chord ratio of no less than about 10% and no greater than about 20%.

41. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end, located a greater radial distance from the axis than the heel end, and tracing an imaginary circle about the axis upon rotation of the impeller; and
an exit angle defined between a line tangent to the imaginary circle at the tip end of the fan blade and a straight line extending tangentially from the tip end of the fan blade, the exit angle being no less than about 35 degrees and no greater than about 60 degrees,
wherein the plate is non-planar, and has a varying axial position with increasing radial distance from the axis, at least a portion of the plate defining an angle of expansion with respect to a plane orthogonal to the axis, the the angle of expansion being greater than about 0 degrees and less than about 25 degrees.

42. The fan as claimed in claim 41, wherein the plurality of fan blades is a first plurality of fan blades, the fan further comprising a second plurality of fan blades coupled to the plate and extending toward the back wall.

43. The fan as claimed in claim 41, wherein each of the plurality of fan blades is curved and has a non-constant radius of curvature.

44. The fan as claimed in claim 41, wherein the exit angle is no less than about 40 degrees and is no greater than about 55 degrees.

45. The fan as claimed in claim 41, wherein an angle between the chord of each blade and a straight line extending from the axis to the tip end of the fan blade is no less than about 5 degrees and is no greater than about 30 degrees.

46. The fan as claimed in claim 41, wherein an angle between the chord of each blade and a straight line extending from the axis to the tip end of the fan blade is no less than about 10 degrees and is no greater than about 25 degrees.

47. The fan as claimed in claim 41, wherein each fan blade has a camber to chord ratio of no less than about 5% and no greater than about 20%.

48. The fan as claimed in claim 41, wherein each fan blade has a camber to chord ratio of no less than about 10% and no greater than about 20%.

49. The fan as claimed in claim 41, wherein the angle of expansion is less than about 20 degrees.

50. The fan as claimed in claim 49, wherein the exit angle is no less than about 40 degrees and is no greater than about 55 degrees.

51. The fan as claimed in claim 49, wherein an angle between the chord of each blade and a straight line extending from the axis to the tip end of the fan blade is no less than about 5 degrees and is no greater than about 30 degrees.

52. The fan as claimed in claim 49, wherein an angle between the chord of each blade and a straight line extending from the axis to the tip end of the fan blade is no less than about 10 degrees and is no greater than about 25 degrees.

53. The fan as claimed in claim 49, wherein each fan blade has a camber to chord ratio of no less than about 5% and no greater than about 20%.

54. The fan as claimed in claim 49, wherein each fan blade has a camber to chord ratio of no less than about 10% and no greater than about 20%.

55. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end; and
a tip end opposite the heel end and located a greater radial distance from the axis than the heel end, wherein an angle between the chord of the fan blade and a straight line extending from the axis to the tip end of the fan blade is no less than about 5 degrees and is no greater than about 30 degrees,
wherein the plate is non-planar, and has a varying axial position with increasing radial distance from the axis, at least a portion of the plate defining an angle of expansion with respect to a plane orthogonal to the axis, the the angle of expansion being greater than about 0 degrees and less than about 25 degrees.

56. The fan as claimed in claim 55, wherein the plurality of fan blades is a first plurality of fan blades, the fan further comprising a second plurality of fan blades coupled to the plate and extending toward the back wall.

57. The fan as claimed in claim 55, wherein each of the plurality of fan blades is curved and has a non-constant radius of curvature.

58. The fan as claimed in claim 55, wherein the angle between the chord and the straight line is no less than about 10 degrees and is no greater than about 25 degrees.

59. The fan as claimed in claim 55, wherein each fan blade has a camber to chord ratio of no less than about 5% and no greater than about 20%.

60. The fan as claimed in claim 55, wherein each fan blade has a camber to chord ratio of no less than about 10% and no greater than about 20%.

61. The fan as claimed in claim 55, wherein the angle of expansion is less than about 20 degrees.

62. The fan as claimed in claim 61, wherein the angle between the chord and the straight line is no less than about 10 degrees and is no greater than about 25 degrees.

63. The fan as claimed in claim 61, wherein each fan blade has a camber to chord ratio of no less than about 5% and no greater than about 20%.

64. The fan as claimed in claim 61, wherein each fan blade has a camber to chord ratio of no less than about 10% and no greater than about 20%.

65. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end; and
a tip end opposite the heel end and located a greater radial distance from the axis than the heel end, wherein the fan blade has a camber to chord ratio of no less than about 5% and no greater than about 20%,
wherein the plate is non-planar, and has a varying axial position with increasing radial distance from the axis, at least a portion of the plate defining an angle of expansion with respect to a plane orthogonal to the axis, the the angle of expansion being greater than about 0 degrees and less than about 25 degrees.

66. The fan as claimed in claim 65, wherein the plurality of fan blades is a first plurality of fan blades, the fan further comprising a second plurality of fan blades coupled to the plate and extending toward the back wall.

67. The fan as claimed in claim 65, wherein each of the plurality of fan blades is curved and has a non-constant radius of curvature.

68. The fan as claimed in claim 65, wherein each fan blade has a camber to chord ratio of no less than about 10% and no greater than about 20%.

69. The fan as claimed in claim 65, wherein the angle of expansion is less than about 20 degrees.

70. The fan as claimed in claim 69, wherein each fan blade has a camber to chord ratio of no less than about 10% and no greater than about 20%.

71. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising a chord;
a heel end;
a tip end opposite the heel end, located a greater radial distance from the axis than the heel end, and tracing an imaginary circle about the axis upon rotation of the impeller;
an intake angle defined between the chord of the fan blade and a straight line extending tangentially from the heel end of the fan blade, the intake angle being no less than about 20 degrees and no greater than about 50 degrees, and
an exit angle defined between a line tangent to the imaginary circle at the tip end of the fan blade and a straight line extending tangentially from the tip end of the fan blade, the exit angle being no less than about 35 degrees and no greater than about 60 degrees.

72. The fan as claimed in claim 71, wherein the plurality of fan blades is a first plurality of fan blades, the fan further comprising a second plurality of fan blades coupled to the plate and extending toward the back wall.

73. The fan as claimed in claim 71, wherein each of the plurality of fan blades is curved and has a non-constant radius of curvature.

74. The fan as claimed in claim 71, wherein the exit angle is no less than about 40 degrees and is no greater than about 55 degrees.

75. The fan as claimed in claim 71, wherein an angle between the chord of each blade and a straight line extending from the axis to the tip end of the fan blade is no less than about 5 degrees and is no greater than about 30 degrees.

76. The fan as claimed in claim 71, wherein an angle between the chord of each blade and a straight line extending from the axis to the tip end of the fan blade is no less than about 10 degrees and is no greater than about 25 degrees.

77. The fan as claimed in claim 71, wherein each fan blade has a camber to chord ratio of no less than about 5% and no greater than about 20%.

78. The fan as claimed in claim 71, wherein each fan blade has a camber to chord ratio of no less than about 10% and no greater than about 20%.

79. The fan as claimed in claim 71, wherein the intake angle is no less than about 27 degrees and is no greater than about 45 degrees.

80. The fan as claimed in claim 79, wherein the exit angle is no less than about 40 degrees and is no greater than about 55 degrees.

81. The fan as claimed in claim 79, wherein an angle between the chord of each blade and a straight line extending from the axis to the tip end of the fan blade is no less than about 5 degrees and is no greater than about 30 degrees.

82. The fan as claimed in claim 79, wherein an angle between the chord of each blade and a straight line extending from the axis to the tip end of the fan blade is no less than about 10 degrees and is no greater than about 25 degrees.

83. The fan as claimed in claim 79, wherein each fan blade has a camber to chord ratio of no less than about 5% and no greater than about 20%.

84. The fan as claimed in claim 79, wherein each fan blade has a camber to chord ratio of no less than about 10% and no greater than about 20%.

85. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end and located a greater radial distance from the axis than the heel end, wherein an angle between the chord of the fan blade and a straight line extending from the axis to the tip end of the fan blade is no less than about 5 degrees and is no greater than about 30 degrees; and
an intake angle defined between the chord of the fan blade and a straight line extending tangentially from the heel end of the fan blade, the intake angle being no less than about 20 degrees and no greater than about 50 degrees.

86. The fan as claimed in claim 85, wherein the plurality of fan blades is a first plurality of fan blades, the fan further comprising a second plurality of fan blades coupled to the plate and extending toward the back wall.

87. The fan as claimed in claim 85, wherein each of the plurality of fan blades is curved and has a non-constant radius of curvature.

88. The fan as claimed in claim 85, wherein the angle between the chord and the straight line extending from the axis to the tip end of the fan blade is no less than about 10 degrees and is no greater than about 25 degrees.

89. The fan as claimed in claim 85, wherein each fan blade has a camber to chord ratio of no less than about 5% and no greater than about 20%.

90. The fan as claimed in claim 85, wherein each fan blade has a camber to chord ratio of no less than about 10% and no greater than about 20%.

91. The fan as claimed in claim 85, wherein the intake angle is no less than about 27 degrees and is no greater than about 45 degrees.

92. The fan as claimed in claim 91, wherein the angle between the chord and the straight line extending from the axis to the tip end of the fan blade is no less than about 10 degrees and is no greater than about 25 degrees.

93. The fan as claimed in claim 91, wherein each fan blade has a camber to chord ratio of no less than about 5% and no greater than about 20%.

94. The fan as claimed in claim 91, wherein each fan blade has a camber to chord ratio of no less than about 10% and no greater than about 20%.

95. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end and located a greater radial distance from the axis than the heel end;
an intake angle defined between the chord of the fan blade and a straight line extending tangentially from the heel end of the fan blade, the intake angle being no less than about 20 degrees and no greater than about 50 degrees; and
a camber to chord ratio of no less than about 5% and no greater than about 20%.

96. The fan as claimed in claim 95, wherein the plurality of fan blades is a first plurality of fan blades, the fan further comprising a second plurality of fan blades coupled to the plate and extending toward the back wall.

97. The fan as claimed in claim 95, wherein each of the plurality of fan blades is curved and has a non-constant radius of curvature.

98. The fan as claimed in claim 95, wherein each fan blade has a camber to chord ratio of no less than about 10% and no greater than about 20%.

99. The fan as claimed in claim 95, wherein the intake angle is no less than about 27 degrees and is no greater than about 45 degrees.

100. The fan as claimed in claim 99, wherein each fan blade has a camber to chord ratio of no less than about 10% and no greater than about 20%.

101. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end, located a greater radial distance from the axis than the heel end, and tracing an imaginary circle about the axis upon rotation of the impeller, wherein an angle between the chord of the fan blade and a straight line extending from the axis to the tip end of the fan blade is no less than about 5 degrees and is no greater than about 30 degrees; and
an exit angle defined between a line tangent to the imaginary circle at the tip end of the fan blade and a straight line extending tangentially from the tip end of the fan blade, the exit angle being no less than about 35 degrees and no greater than about 60 degrees.

102. The fan as claimed in claim 101, wherein the plurality of fan blades is a first plurality of fan blades, the fan further comprising a second plurality of fan blades coupled to the plate and extending toward the back wall.

103. The fan as claimed in claim 101, wherein each of the plurality of fan blades is curved and has a non-constant radius of curvature.

104. The fan as claimed in claim 101, wherein the angle between the chord and the straight line is no less than about 10 degrees and is no greater than about 25 degrees.

105. The fan as claimed in claim 101, wherein each fan blade has a camber to chord ratio of no less than about 5% and no greater than about 20%.

106. The fan as claimed in claim 101, wherein each fan blade has a camber to chord ratio of no less than about 10% and no greater than about 20%.

107. The fan as claimed in claim 101, wherein the exit angle is no less than about 40 degrees and is no greater than about 55 degrees.

108. The fan as claimed in claim 107, wherein the angle between the chord and the straight line is no less than about 10 degrees and is no greater than about 25 degrees.

109. The fan as claimed in claim 107, wherein each fan blade has a camber to chord ratio of no less than about 5% and no greater than about 20%.

110. The fan as claimed in claim 107, wherein each fan blade has a camber to chord ratio of no less than about 10% and no greater than about 20%.

111. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end, located a greater radial distance from the axis than the heel end, and tracing an imaginary circle about the axis upon rotation of the impeller;
an exit angle defined between a line tangent to the imaginary circle at the tip end of the fan blade and a straight line extending tangentially from the tip end of the fan blade, the exit angle being no less than about 35 degrees and no greater than about 60 degrees; and
a camber to chord ratio of no less than about 5% and no greater than about 20%.

112. The fan as claimed in claim 111, wherein the plurality of fan blades is a first plurality of fan blades, the fan further comprising a second plurality of fan blades coupled to the plate and extending toward the back wall.

113. The fan as claimed in claim 111, wherein each of the plurality of fan blades is curved and has a non-constant radius of curvature.

114. The fan as claimed in claim 111, wherein each fan blade has a camber to chord ratio of no less than about 10% and no greater than about 20%.

115. The fan as claimed in claim 111, wherein the exit angle is no less than about 40 degrees and is no greater than about 55 degrees.

116. The fan as claimed in claim 115, wherein each fan blade has a camber to chord ratio of no less than about 10% and no greater than about 20%.

117. A centrifugal fan, comprising:
a housing comprising an inlet wall and a back wall spaced axially away from and opposite the inlet wall, the inlet wall having an aperture to allow gases to enter the housing; and
an impeller contained at least partially within the housing and rotatable about an axis with respect to the housing, the impeller comprising
a plate extending radially away from the axis; and
a plurality of fan blades on the plate, each fan blade comprising
a chord;
a heel end;
a tip end opposite the heel end and located a greater radial distance from the axis than the heel end, wherein an angle between the chord of the fan blade and a straight line extending from the axis to the tip end of the fan blade is no less than about 5 degrees and is no greater than about 30 degrees; and
a camber to chord ratio of no less than about 5% and no greater than about 20%.

118. The fan as claimed in claim 117, wherein the plurality of fan blades is a first plurality of fan blades, the fan further comprising a second plurality of fan blades coupled to the plate and extending toward the back wall.

119. The fan as claimed in claim 117, wherein each of the plurality of fan blades is curved and has a non-constant radius of curvature.

120. The fan as claimed in claim 117, wherein each fan blade has a camber to chord ratio of no less than about 10% and no greater than about 20%.

121. The fan as claimed in claim 117, wherein the angle between the chord and the straight line is no less than about 10 degrees and is no greater than about 25 degrees.

122. The fan as claimed in claim 121, wherein each fan blade has a camber to chord ratio of no less than about 10% and no greater than about 20%.
